(19) United States
(12) Patent Application Publication
(10) Pub. No.: US 2014/0250309 A1
(43) Pub. Date: Sep. 4, 2014

(54) PREDICTIVE SELF CALIBRATED POWER CONTROL

(71) Applicant: QUALCOMM Incorporated, San Diego, CA (US)

(72) Inventor: Kai P. Dietze, San Francisco, CA (US)

(21) Appl. No.: 13/782,396

(22) Filed: Mar. 1, 2013

(51) Int. Cl. G06F 1/26

(52) U.S. Cl. CPC G06F 1/26
USPC 713/300

(57) ABSTRACT

A method of controlling power in a circuit includes characterizing a power behavior of the circuit, from a circuit input to a circuit output during a manufacturing process of the circuit, wherein the characterizing may be at one or more of a wafer, chip or circuit board level, predicting the power behavior of the circuit on the basis of the characterizing, and controlling the power of signals transmitted from the output of the circuit on the basis of the predicting. An apparatus for controlling signal power in a circuit includes a transmitter to transmit an output signal, a receiver coupled to the transmitter by a loopback path, and a digital signal processor coupled to the transmitter and receiver, wherein the signal processor predicts and adjusts a power level of the output signal from the transmitter based on characterizing a loopback signal and known response characteristics of the circuit.

### BACKGROUND

1. Field

The present disclosure relates generally to wireless communication systems. More specifically, the present disclosure related to methods and apparatus for controlling power in a transmit/receive circuit by predicting the behavior of the circuit on the basis of characterizing the circuit as manufactured.

2. Background

Wireless communication devices have become smaller and more powerful as well as more capable. Increasingly users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipments, and similar terms.

A wireless communication system may support communication for multiple wireless communication devices at the same time. In use, a wireless communication device may communicate with one or more base stations by transmissions on the uplink and downlink. Base stations may be referred to as access points, Node Bs, or other similar terms. The uplink or reverse link refers to the communication link from the wireless communication device to the base station, while the downlink or forward link refers to the communication from the base station to the wireless communication devices.

Wireless communication systems may be multiple access systems capable of supporting communication with multiple users by sharing the available system resources, such as bandwidth and transmit power. Examples of such multiple access systems include code division multiple access (CDMA) systems, time division multiple access (TDMA) systems, frequency division multiple access (FDMA) systems, wideband code division multiple access (WCDMA) systems, global system for mobile (GSM) communication systems, enhanced data rates for GSM evolution (EDGE) systems, and orthogonal frequency division multiple access (OFDMA) systems.

Knowing the instantaneous output power of the communication device at the chip or somewhere along the path outside of the chip (e.g., at the antenna, after the coexistence filter or diplexer, etc.) is important in ensuring proper power control and that at the antenna regulatory emission requirements are met. The assessment of the instantaneous power is performed through measurements usually by coupling part of the output power into a measurement circuit (usually back into the original chip) for power estimation. This process introduces inherent measurement errors that get worse at higher carrier frequencies. These errors come from the power coupling circuit (a coupler can be internal or external to the chip), the power estimation circuit (which must measure power accurately over the entire power range), and any other circuit tolerances in the power measurement path. Because of these measurement errors, the measured output power could be several decibels (dB) away from to true output power.

The desire to perform power control arises from the need to meet regulatory requirements and can also be required as part of a wireless communication standard. For example, a base station or access point can instruct a mobile/nomadic station to lower/increase its transmitted power based on the signal it receives from the subscriber unit. Similarly, a transmitting station can limit its own power in order to not violate regulatory or wireless standard emissions. Either of these two cases illustrates the need for accurate power control.

Traditionally, a power measuring circuit is built into a chip. In this method, a part of the transmitted signals power is coupled into the power measurement circuit. The power can be coupled either internally inside the chip boundary or after an external component (e.g., an xPA-external Power Amplifier, a BPF-Band pass filter, a Diplexer, etc.), as shown in FIG. 3. The dashed lines and blocks are optional example configurations. The power measurement circuit estimates the power and informs a digital processing unit the result of its estimate. The digital processing unit then decides whether to increase or decrease the analog and/or digital gain to turn the power up or down. Note that a coupler (shown at various optional locations) reduces the potential output power since some of the power is siphoned off before it reaches the antenna and if a receiver (RX) (not shown) uses the same path as a transmitter (TX) and encounters the coupler it will also affect RX performance.

This method has as a drawback in that the power measuring circuit has to work accurately over chip-to-chip process variations, temperature, frequency, and other errors that may be introduced by the variability in the measuring circuit.

There is a need, therefore, for an approach to power control that avoids the perturbation ambiguities of the measurement circuitry and reduces overall chip real estate.

### SUMMARY

A method of self-calibrated power control (SCPC) in a circuit includes characterizing a power behavior of the circuit, from a circuit input to a circuit output during manufacturing of the circuit, or in-situ on a chip by chip basis, predicting the power behavior of the circuit on the basis of the characterizing, and controlling the power of signals transmitted from the output of the circuit on the basis of the predicting.

An apparatus for controlling signal power in a circuit includes a transmitter to transmit an output signal, a receiver coupled to the transmitter by a loopback path, and a digital signal processor coupled to the transmitter and receiver, wherein the signal processor predicts and adjusts a power level of the output signal (through analog and/or digital means) from the transmitter based on characterizing a loopback signal and known response characteristics of the circuit.

An apparatus for controlling power in a circuit includes means for transmitting an output signal, means for receiving a loopback signal from the transmitting means; means for predicting and adjusting a power level of the output signal from the transmitter means based on characterizing a loopback signal and known response characteristics of the circuit.

A non-transitory computer readable media including program instructions which when executed by a processor cause the processor to perform the method of characterizing a power behavior of the circuit, from a circuit input to a circuit output during a manufacturing process of the circuit (or on chip), predicting the power behavior of the circuit on the basis of the characterizing, and controlling the power of signals transmitted from the output of the circuit on the basis of the predicting.

### BRIEF DESCRIPTION OF THE DRAWINGS

FIG. 1 illustrates one configuration of a wireless communication system, in accordance with certain embodiments of the disclosure.

FIG. 2 illustrates a block diagram of an example of electronic components capable of transmitting in accordance with certain embodiments of the disclosure.

FIG. 3 is a block diagram of a power measurement circuit in a transmitter/receiver.

FIG. 4 depicts a generic AMAM output power vs. input power curve according to an embodiment.

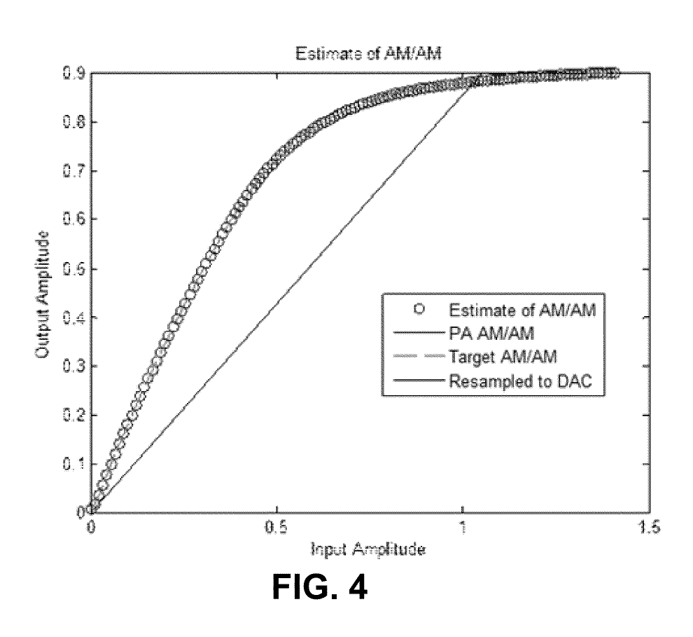

FIG. 5 shows a circuit for self calibrated power control, in accordance with certain embodiments of the disclosure.

FIG. 6 is a block diagram of a method 600 of controlling power in a circuit, in accordance with certain embodiments of the disclosure.

### DETAILED DESCRIPTION

Various aspects are now described with reference to the drawings. In the following description, for purposes of explanation, numerous specific details are set forth in order to provide a thorough understanding of one or more aspects. It may be evident however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the term “determining” encompasses a wide variety of actions and therefore, “determining” can include calculating, computing, processing, deriving, investigating, looking up (e.g., looking up in a table, a database or another data structure), ascertaining and the like. Also, “determining” can include resolving, selecting choosing, establishing, and the like.

The phrase “based on” does not mean “based only on,” unless expressly specified otherwise. In other words, the phrase “based on” describes both “based only on” and “based at least on.”

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Disk and disc, as used herein, includes compact disk (CD), laser disk, optical disc, digital versatile disk (DVD), floppy disk, and Blu-ray ® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

Amplifiers may have a linear range and a non-linear range. In order to avoid signal distortion, amplifiers may be used in the linear range. In the non-linear range, the signals may be subject to amplitude to amplitude modulation and amplitude to phase modulation. This may be caused when the ratio of input power to output power is not constant when the amplifier is operated in the non-linear range. As the input signal amplitude increases, a disproportionate increase in the output power may occur. This may be referred to as amplitude modulation to amplitude modulation (AM-AM), since an unwanted additional amplitude modulation is experienced.

AM-AM may be experienced up to a maximum output power of the amplifier at which point the input values may result in the same output values. When this occurs it may be known as compression, and may result in the signal being clipped. The signal may have square or sharp edges in the time domain, which implies that higher frequency components may be generated. This may cause out of band emissions in addition to the distortion of the amplified signal.

The output phase of the signal may not be constant at different amplitude levels of the input signal undergoing amplification. The amplified signal may experience a phase modulation as a function of the input amplitude. This relationship may not be constant, that is, the relationship may be non-linear. This may be referred to amplitude modulation to phase modulation (AM-PM).

A power amplifier may be driven harder in order to obtain more efficiency from the power amplifier. Typically, operating a power amplifier at a higher efficiency comes at a price of amplitude and phase distortion of the input signal. Pre-distortion techniques may be used to correct these distortions. However, the power amplifier may have a memory effect. This memory effect means that the actual observed distortion depends on the nature of the waveform to be transmitted. As a result the AM-AM or AM-PM characteristics of the power amplifier may depend on the nature of the waveform of the input signal. It is desirable to measure the AM-AM and AM-PM characteristics of the power amplifier when a transmitter transmits a waveform similar to an actual transmit waveform. This testing is usually done during the manufacturing or assembly of the transmitter that includes the power amplifier. The power amplifier may amplify signals for GSM communication systems, EDGE systems, WCDMA systems, among others.

During testing the measured mean AM-AM and AM-PM characteristics of the power amplifier may be used to pre-distort the transmit waveform. The power amplifier may also be calibrated using an actual transmit signal, which enables pre-distortion techniques to be used. These pre-distortion techniques may vary depending on the system where the power amplifier will ultimately be used. Each system may have different specifications for the power amplifiers used on that system. By using an actual transmit signal to calibrate the power amplifier the same power amplifier may be used for each type of communication system.

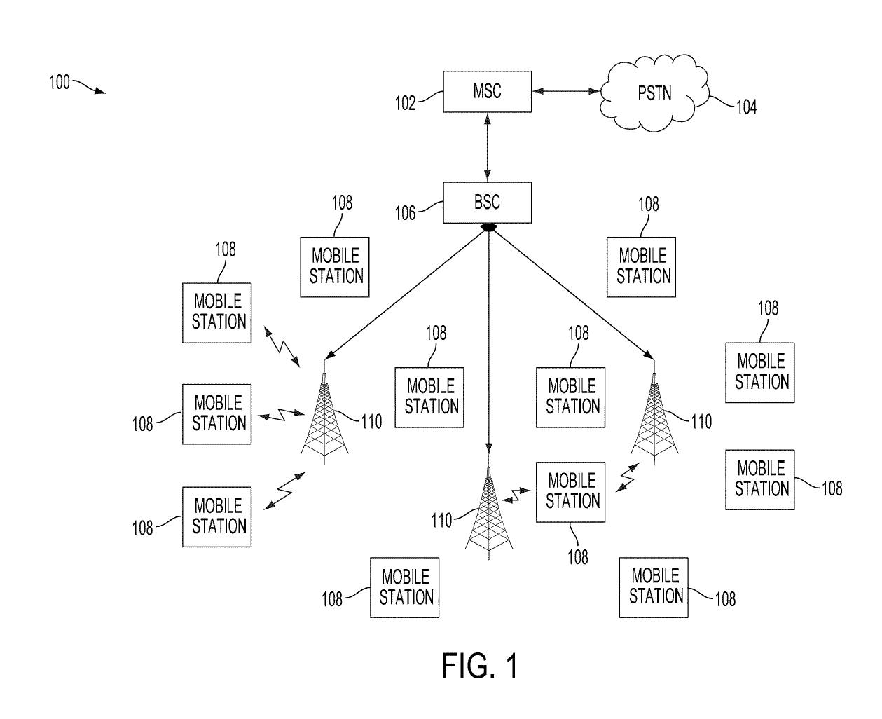

FIG. 1 illustrates a wireless system 100 that may include a plurality of mobile stations 108, a plurality of base stations 110, a base station controller (BSC) 106, and a mobile switching center (MSC) 102. The system 100 may be GSM, EDGE, WCDMA, CDMA, etc. The MSC 102 may be configured to interface with a public switched telephone network (PTSN) 104. The MSC may also be configured to interface with the BSC 106. There may be more than one BSC 106 in the system 100. Each base station 110 may include at least one sector, where each sector may have an omnidirectional antenna or an antenna pointed in a particular direction radially away from the base stations 110. Alternatively, each sector may include two antennas for diversity reception. Each base station 110 may be designed to support a plurality of frequency assignments. The intersection of a sector and a frequency assignment may be referred to as a channel. The mobile stations 108 may include cellular or portable communication system (PCS) telephones.

During operation of the cellular telephone system 100, the base stations 110 may receive sets of reverse link signals from sets of mobile stations 108. The mobile stations 108 may be involved in telephone calls or other communications. Each reverse link signal received by a given base station 110 may be processed within that base station 110. The resulting data may be forwarded to the BSC 106. The BSC 106 may provide call resource allocation and mobility management functionality including the orchestration of soft handoffs between base stations 110. The BSC 106 may also route the received data to the MSC 102, which provides additional routing services for interfacing with the PSTN 104. Similarly, the PTSN 104 may interface with the MSC 102, and the MSC 012 may interface with the BSC 106, which in turn may control the base stations 110 to transmit sets of forward link signals to sets of mobile stations 108.

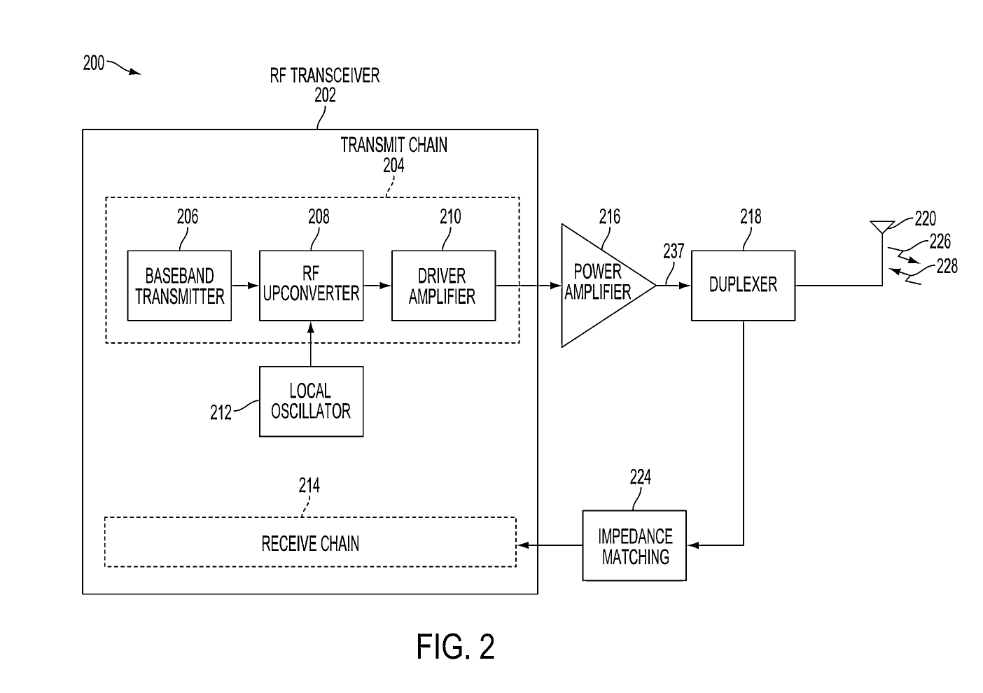

FIG. 2 is a block diagram illustrating one example of electronic components 200, capable of transmitting. The electronic components 200 may be part of a mobile station 108, a base station 110, or any other type of device capable of transmitting. The electronic components 200 may include a power amplifier (PA) 216. Tests may be conducted in order to optimize the performance and efficiency of the amplifier 216. In one scenario the tests may be conducted before the components 200 are marketed, that is, before an end user acquires the components 200. In one example, the configuration 200 may include a radio frequency (RF) transceiver 202. The transceiver 202 may transmit outgoing signals 226 and receive incoming signals 228 via an antenna 220. A transmit chain 204 may be used to process signals that are to be transmitted and a receive chain 214 may be implemented to process signals received by the transceiver 202. An incoming signal 228 may be processed by a duplexer 218 and impedance matching 224 of the incoming signal 228 may occur. The incoming signal 228 may then be processed by the receive chain 214.

The desire to do power control arises from the need to meet regulatory requirements and may also be required by a wireless communication standard. For example, a base station or access point can instruct a mobile/nomadic station to lower/increase its transmitted power based on the received signal it receives from the subscriber unit. Similarly, a transmitting station can limit its own power in order to not violate regulatory or wireless standard emissions. Either of these two cases illustrates the need for accurate power control.

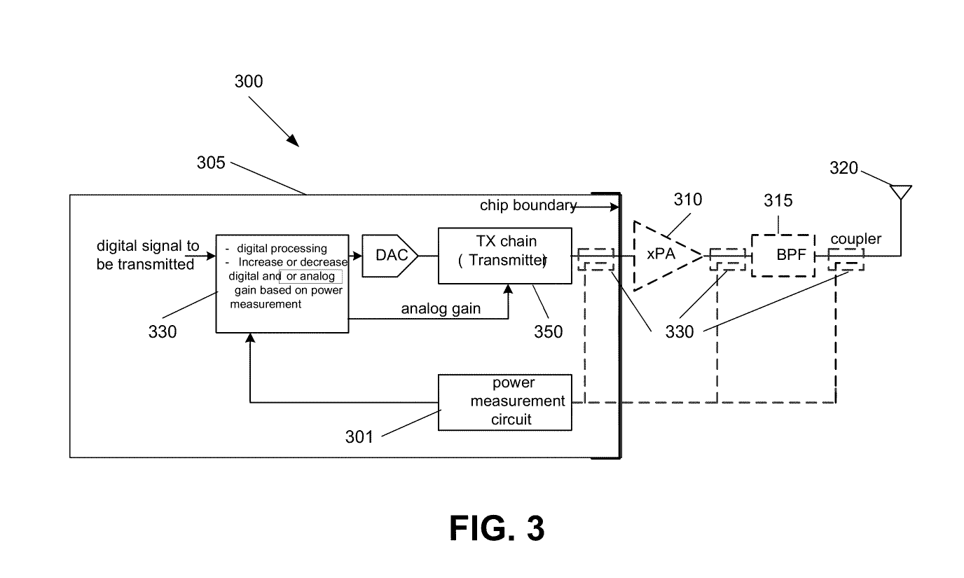

FIG. 3 illustrates one example of a conventional transceiver 300 including power control. Traditionally, a power measuring circuit 301 is built into a chip 305. In this method, a part of the transmitted signals power is coupled into the power measurement circuit 301. The power can be coupled either internally inside the chip boundary or after an external component (e.g., an xPA-external Power Amplifier 310, a BPF-Band pass filter 315, a Diplexer, etc.) following detection by an antenna 320. The dashed lines and blocks are optional example configurations. The power measurement circuit 301 estimates the power and informs a digital processing unit 330 the result of its estimate. The digital processing unit 330 then decides whether to increase or decrease the analog and/or digital gain. Note that a coupler 340 (shown at various optional locations) reduces the potential output power since some of the power is siphoned off before it reaches the antenna 320 and if a receiver (RX) (not shown) uses the same path as a transmitter (TX) 350 and encounters the coupler 340 it will also affect RX performance.

This method has as a drawback in that the power measuring circuit 301 has to work accurately over chip-to-chip process variations, temperature, frequency, and other errors that may be introduced by the variability in the measuring circuit 301.

There is a need, therefore, for an approach to power control that avoids the perturbation ambiguities of the measurement circuitry and reduces overall chip real estate.

Disclosed is a method and apparatus to overcome problems associated with errors in measuring output power from the chip or at any point along the board (e.g., antenna, coexistence filter). The method is based on predicting the output power instead of measuring the output power during operation and therefore bypasses the measurement errors. What makes output power hard to predict is the non-linear nature of the amplifiers and the varying gain of the RF blocks over chip process.

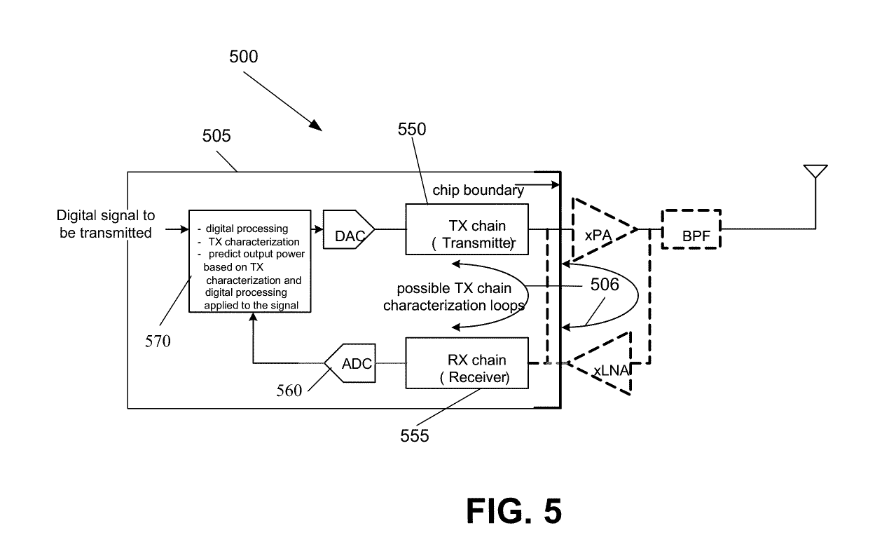

FIG. 5 shows an embodiment of a circuit 500 for self calibrated power control on a chip 505. This method requires characterizing the behavior of the power generating circuits from input to output (i.e., the TX path). This characterization process may be done routinely on chip to perform digital-pre-distortion (DPD) to compensate for the non-linearities in a TX path 550 on a chip by chip basis. This information can be re-used to predict the output power without having to measure the instantaneous output power directly. The TX path can be characterized through any loopback path 506 whether it be internal to the chip or through an external component that is looped back into the chip 505 for characterization through a receive path. The degree of characterization necessary depends on if the TX path 550 exhibits memory or memory-less non-linear behavior. In the case of memory-less behavior, for example, the AM-AM and AM-PM characterization of the TX path 550 is sufficient otherwise a more complete characterization of the TX path 550 is necessary.

In the case of a memory-less non-linear TX path 506, for example, the AM-AM and AM-PM behavior of the TX path 550 is sufficient to characterize the TX path 550. The AM-AM-PM curves estimated through the loopback path 506 describe uniquely how the TX path 550 is going to perform as a function of input power in a relative manner. In order to resolve the ambiguity between relative and absolute output powers, a point on the curve of the AM-AM curve has to be known or measured a priori (the power measurement can be done on chip or on the board itself through an external measuring device). Based on measurements, Pₛₐₜ is a stable point to establish a relationship between relative to absolute power. Pₛₐₜ is the output power at which the TX circuit saturates and the advantage of using Pₛₐₜ is that it is fairly stable over tolerant process conditions and has relatively little variation.

In the loopback path 506 an analog transmit signal from the transmitter 550 is received by the receiver 555. An analog-to-digital converter 560 converts the received signal to a digital format for processing in a digital processor 570. The digital processor 570 characterizes the received transmit signal and processes the incoming digital signal being transmitted to determine an adjusted gain in the signal to be converted from digital to analog format in a digital-to-analog converter (DAC) for transmission from the transmitter chain 550.

The biggest advantage of this method, as mentioned earlier, is that the output power can be accurately predicted (sometimes even better than measuring it directly through an internal measuring circuit and coupler configuration). This means that the external coupler which is used to pipe some of the energy into a measurement circuit can be eliminated. Eliminating the coupler increases the potential output power of the TX path as well as reduces the insertion loss on the RX path, which degrades performance by increasing the effective noise figure when the RX and TX both have the coupler in its path. Additionally, since the Psat measurements are very stable from chip-to-chip and board-to-board, the Psat can be measured at the output of several chips (or at any place on the board or antenna) and characterized and used at the point that will resolve the relative ambiguity of the AM-AM and AM-PM curves (for memory-less non-linearities) or also for PA that have memory and are characterized with a non-linearity with memory. Characterizing Psat externally will also remove the need for a measurement circuit on chip.

There are three potential ways to use the AM-AM and AM-PM curves to predict output power for memory-less non-linearities:

First, In conjunction with DPD—When used with DPD (digital-pre-distortion), the information contained in the estimated AM-AM and AM-PM curves can be used to effectively linearize the TX path through digital pre-distortion. The effective gain of the linearization circuit plus the TX path can be varied and adjusted to obtain any desired gain from input to output. With the knowledge of Psat, the desired output power, and the input power (which is known), an absolute gain from input to output can be computed that is needed to produce a given output power. The DPD circuit can be set to invert the signal in such a way as to produce the desired end to end gain. Hence the desired output power can be accurately set by adjusting the DPD circuit.

Second, without DPD (optimal)—Knowing the AM-AM curve absolutely (after including Psat information) gives a complete description of the response of the TX path versus input. If the input distribution is known (which it is, for a given modulation), the output power can be predicted in a straight-forward fashion through an integral that weights the distribution against the AM-AM curve. In addition, a digital and/or analog gain can be computed in a similar fashion that will produce any desired output power without having to measure the resultant output signal.

Third, without DPD (reduced complexity)—these methods are based on finding the closest linear match to the AM-AM curve and assuming the input to output relationship of the TX path is linear. This linear approximation, together with the knowledge of a point such as Pₛₐₜ, can be used to have a good approximation of the output power from the input power. A correction factor may also be included at high output powers where the AM-AM curve is most likely to be non-linear to compensate for inaccuracies in this method. Alternatively, the optimal solution without DPD, second method above, can be solved for some powers and the remaining digital gains that produce other output powers can be interpolated from the optimal results.600

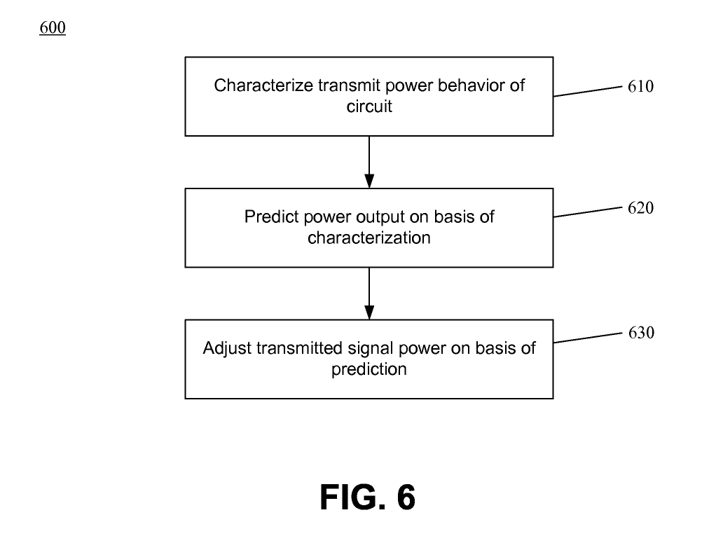

FIG. 6 is a block diagram of a method 600 of controlling power in a circuit. In method block 610 the circuit transmission chain—from digital signal input to power amplifier output—is characterized. The characterization may involve one or more of testing the circuit at various stages of manufacture prior to operational use, so that the control of power output is based on the specific performance of the integrated circuit chip. The characterization may also be based on circuit simulation results, or a combination of in situ characterization and simulation. The characterization may include measuring measuring at least one or more of a signal amplitude output vs. a signal amplitude input (AM-AM), a signal phase output vs. a signal amplitude input (AM-PM).

In method block 620 the power output may be predicted on the basis of the characterization process performed in block 610. The prediction may be based on one or more of the actual circuit testing and simulation results. The simulation results may incorporate results from circuit testing to establish simulation parameters specific to the tested chip.

In method block 630 the power variable signal may be adjusted, e.g., adjusting the digital signal in the signal processor 570, and/or amplification in the analog transmitter 550.

SCPC can also work over temperature by re-characterizing the TX path after a certain change in die temperature has occurred (based on measurements by the on-die temperature sensors). This would mean measuring the AM-AM and AM-PM curves at the chip level again so as to have a valid response for that given temperature. This has to be done anyways for DPD and this information can also be used to update the SCPC algorithm to improve its performance over temperature.

In summary, all these methods are based on the characterization of the TX path and predicting the output power instead of a circuit that measures the actual instantaneous power.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method of controlling power in a circuit comprises:
characterizing through a characterization loop a power behavior of the circuit, from a circuit input to a circuit output during one or more of a manufacturing process of the circuit, wherein the characterizing may be at one or more of a wafer, chip or circuit board level;
predicting the power behavior of the circuit on the basis of the characterizing; and
controlling the power of signals transmitted from the output of the circuit on the basis of the predicting.

2. The method of claim 1, wherein the circuits comprise one or more of a transmitter and a receiver.

3. The method of claim 1, further comprising linearizing the power output using digital pre-distortion (DPD).

4. The method of claim 1, wherein the circuit comprises memory-less non-linearity behavior.

5. The method of claim 4, the characterizing further comprising measuring a signal amplitude output vs. a signal amplitude input (AM-AM).

6. The method of claim 4, the characterizing further comprising measuring a signal phase output vs. a signal amplitude input (AM-PM).

7. An apparatus for controlling signal power in a circuit, comprising:
a transmitter to transmit an output signal;
a receiver coupled to the transmitter by a loopback path; and
a digital signal processor coupled to the transmitter and receiver, wherein the signal processor predicts and adjusts a power level of the output signal from the transmitter based on characterizing a loopback signal and known response characteristics of the circuit.

8. The apparatus of claim 7, further comprising:
a digital-to-analog converter (DAC) between the digital signal processor and the transmitter; and
an analog-to-digital converter (ADC) between the receiver and the digital signal processor.

9. The apparatus of claim 7, wherein the known response characteristics are determined using built in self-test circuitry.

10. The apparatus of claim 7, wherein the known response characteristics are determined by characterization of the circuit as part of the manufacturing process.

11. The apparatus of claim 7, wherein the power level is linearized based on digital pre-distortion (DPD) by the digital signal processor.

12. The apparatus of claim 7, wherein the circuit comprises memory-less non-linear behavior.

13. The apparatus of claim 12, wherein the characterizing further comprises measuring a signal amplitude output vs. a signal amplitude input (AM-AM).

14. The apparatus of claim 12, wherein the characterizing further comprises measuring a phase amplitude output vs. a signal amplitude input (AM-PM).

15. An apparatus for controlling power in a circuit, comprising:
means for transmitting an output signal;
means for receiving a loopback signal from the transmitting means;
means for predicting and adjusting a power level of the output signal from the transmitter means based on characterizing a loopback signal and known response characteristics of the circuit.

16. The apparatus of claim 15, wherein the means for predicting and adjusting the power level is a digital processing means.

17. The apparatus of claim 16, further comprising:
means to convert a digital signal to an analog signal, the conversion means arranged between the digital processing means and the transmitting means; and
means to convert an analog signal to a digital signal, the conversion means arranged between the receiving means and the digital processing means.

18. The apparatus of claim 16, further comprising built in self test means to determine the known response characteristics of the circuit.

19. The apparatus of claim 16, wherein the power level is linearized based on digital pre-distortion (DPD) by the digital processing means.

20. The apparatus of claim 16, wherein the circuit comprises memory-less non-linear behavior.

21. The apparatus of claim 20, wherein the characterizing further comprises measuring a signal amplitude output vs. a signal amplitude input (AM-AM).

22. The apparatus of claim 20, wherein the characterizing further comprises measuring a phase amplitude output vs. a signal amplitude input (AM-PM).

23. A non-transitory computer readable media containing instructions which when executed by a processor cause the processor to perform the following steps:
characterizing a power behavior of the circuit, from a circuit input to a circuit output during a manufacturing process of the circuit;
predicting the power behavior of the circuit on the basis of the characterizing; and
controlling the power of signals transmitted from the output of the circuit on the basis of the predicting.

24. The non-transitory computer readable media of claim 23, wherein the circuits comprise one or more of a transmitter and a receiver.

25. The non-transitory computer readable media of claim 23, the method further comprising linearizing the power output using digital pre-distortion (DPD).

26. The non-transitory computer readable media of claim 24, wherein the circuit comprises memory-less non-linearity behavior.

27. The non-transitory computer readable media of claim 26, the method further comprising measuring a signal amplitude output vs. a signal amplitude input (AM-AM).

28. The non-transitory computer readable media of claim 26, the method further comprising measuring a signal phase output vs. a signal amplitude in (AM-PM).
